(19) United States
(12) Patent Application Publication
(10) Pub. No.: US 2013/0304548 A1
(43) Pub. Date: Nov. 14, 2013

(54) METHOD AND SYSTEM FOR PROTECTING AND MARKETING COPYRIGHT MATERIALS

(71) Applicants: Brandon Jake Cooper, Marietta, GA (US); Andre Joseph Parker, Brighton, TN (US)

(72) Inventors: Brandon Jake Cooper, Marietta, GA (US); Andre Joseph Parker, Brighton, TN (US)

(21) Appl. No.: 13/566,999

(22) Filed: Aug. 3, 2012

Related U.S. Application Data
(60) Provisional application No. 61/646,281, filed on May 12, 2012.

(51) Int. Cl. G06F 21/00; G06Q 30/02

(52) U.S. Cl. 705/14.1; 726/30

(57) ABSTRACT

A unique method of service through a visual and/or audio interruption mechanism has the intent of dramatically reducing piracy. The framework includes audio with interruption mechanism and/or visual interruption mechanism with or without audio, which is combined with the copyrighted material of owners with permission. This mechanism makes consumer enjoyment less delightful by interruption. The invention is primarily a service provided to copyright owner(s) in which their material is flooded by disguised; cloned, interruption files on digital outlets which prevents consumer(s) from downloading their copyrighted material illegally and directed to purchase material legally with advertisement. The inventions business model also includes advertisement space on designated copyrighted materials' file(s). The stock option and rewards program is also within the business model. Clone marketing and AphidByte prints are also key factors.

### CROSS-REFERENCE TO RELATED APPLICATION

This application claims the benefit of priority of U.S. provisional application No. 61/646,281, filed May 12, 2012, the contents of which are herein incorporated by reference.

### BACKGROUND OF THE INVENTION

The present invention relates to methods and systems for protecting and marketing copyright materials. More particularly the present invention relates to an intentional interruption in the form of an audio and/or visual effect including, but not limited to a warning, comical skit and/or intentional advertisement interruption that occurs at a specified or random time frame on copyrighted materials (an approach for providing infringement and piracy reduction service for copyright owners (clients/members), which dramatically reduces unauthorized users from illegally experiencing copyrighted material(s) in their entirety. The present invention also relates to marketing in the form of cloning massive amounts of copyrighted material for copyright owners' in general with or without a streaming interruption. The user stock option, discounts and rewards implementation is also an additional sector of the business model, all of which is interconnected to a control portal.

“Anti-piracy is often described as the attempt to prevent counterfeiting, copyright infringement and other violations of intellectual-property rights. Piracy consists of unauthorized copying; downloading, sharing, and selling. As it pertains to piracy within business models, piracy protection is often in the form of digital rights management (DRM); a term that refers to any project of action that controls access to copyrighted material using technological tactics. i.e., software licensing; encoding into copyrighted material such as compact discs with warnings, digital video disc with warnings, video gaming disc with warnings, and the like.

DRM usually operates on the following criteria: (1) controlling what a consumer can do with copyrighted material once it is distributed, (2) creating a copyright and (3) managing the distribution the copyrighted content. For this to be executed, a DRM program has to precisely define the content, usage rights and the user and the connection between those entities. DRM removes usage control from the user in possession of digital content and directs information to a computer program.

Making a copy of your own legitimately purchased material is perfectly legal as stated in copyright law of the fair use doctrine. Under copyright law, the fair use doctrine gives a consumer the right to make copies of copyrighted material for their own use. You cannot determine how many copies a person has actually made. There are particular situations that negate copyright protection in the favor of the content user such as copying material in the public domain for any usage, and protected copyright material for personal usage. Since a computer program cannot make subjective decisions, many digital rights management plots cannot take fair use into account. Most common DRM encryption plots implement an encryption key that will never cease in which that particular user's device is linked with the specific identification number. The key only decodes when it is derived from its original system.

There are no industry wide standards for DRM. File sharing programs/networks have made distribution of digital content as it relates to copyright law.” (See http://en.wikipedia.org/wiki/Digital_rights_management). The illegal activity done by users around the world has caused rightful owners of copyrighted material to lose a very significant amount of money.

All in all, the preceding information relates to the background of anti-piracy methods of attempted prevention. The service providers' method contains a vastly dissimilar business model.

In regards to implementation into copyrighted materials, each element is/was usually made with individual specifics. For example, a song tag (sound indicating notice) from a disc jockey is mainly used with the intention of gaining notoriety. This form of song tagging is used as self-promotion along with assistance in the performing artists' promotion in general. Granted the tag of such may aid the need for an artist or disc jockey in promotion, it does not prevent consumers from illegally downloading music. Continuous song tags are often made and used by producers, artists, etc. to give notice of creator so any duplication would have to contain that particular tag on it. Visual notices i.e. a movie shows copyright owner as a constant subtitle without going away on the screen but the movie continues to play, is shown to give notice of creator so any duplication would have to have that particular tag on it.

As can be seen, there is a need for improved methods and systems to protect and market copyright materials.

### SUMMARY OF THE INVENTION

In one aspect of the present invention, a implemented method for reducing unauthorized distribution of copyrighted materials comprises incorporating an intentional interruption into copyrighted material in a form of at least one of an audio and visual effect that causes one or more attributes of the resulting intentionally interrupted copyrighted material to be displayed; establishing, in at least one of an audio and visual effect form, from copyrighted materials received from copyright owners, an intentional interruption mechanism incorporated within copyrighted materials, wherein the intentionally interrupted material comprise at least one of a warning, comedy advertisement and general advertisement; and causing to be displayed to a recipient a warning, comical skit or advertisement discouraging illegal acquisition of copyrighted materials, a marketing/advertising commercial by copyright owners and official vendors of copyrighted material, and the abrupt ending of illegally acquired copyrighted material playing at the time. Service providers own the service and business method, not the actual copyright owners' materials which is being interruption and clone integrated.

These and other features, aspects and advantages of the present invention will become better understood with reference to the following drawings, description and claims.

### BRIEF DESCRIPTION OF THE DRAWINGS

FIG. 1 is a flow chart showing strategic placing for intentional interruption where the Client (copyright owner) enters file of choice into clone generator; staff reviews copyright protected material of the Client (copyright owner) which has been uploaded; the Client (copyright owner) selects “Add Interruption Sequence”; the Client (copyright owner) decides which type of interruption will be utilized i.e., audio, visual effect, or a combination of both; the intentional interruption mechanism section is chosen by the Client (copyright owner) by a drop down box or checkbox selection provided in clone generator program; the Client (copyright owner) reviews the finished copyrighted material, then approves or disapproves to proceed with clone purchase. If dissatisfied, the client can revise and edit the placement of the intentional interruption according to the clients' preference, and the clone is then pending reviewed by staff. If clone is approved, service providers charge the fee for the services rendered. If disapproved, client has option of re-uploading with modification or discontinue;

FIG. 2 is a flow step showing how to determine which intentional interruption to use, where the Client decides whether to use the intentional interruption (or interruptions) and have the option to select which type from their preset uploaded sounds or visuals in a drop down or checkbox selection method, Otherwise the default company warning is used if none is selected;

FIG. 3 is a flow step showing time of placement for intentional interruption, where a random time of placement is the default intentional interruption sequence, otherwise, client will have the option for beginning, middle, or end for the files' intentional interruption placement;

FIG. 4 is a flow chart showing intentional interruption duration, where intentional interruption is inserted at a randomized or selected point of interest by the client in the clients' (copyright owners') protected material; as a second option by client; the intentional interruption lasts for the duration of the clients' (copyright owners') protected material regardless of how early or late the interruption is inserted i.e. if the copyrighted material is 1 hour in length and the intentional interruption is placed 5 minutes into the copyrighted material, the intentional interruption will continue for the remaining 55 minutes of the copyrighted material; and if the selected intentional interruption duration is shorter than the remaining time of the clients' (copyright owners') copyrighted material, the intentional interruption if chosen by member, can replay consecutively until the conclusion of the copyrighted material i.e. if the intentional interruption duration is 30 seconds, but the remaining time of the copyrighted material is 2 minutes, the intentional interruption will replay 4 times. The interruption can also occur randomly until ending time of copyrighted material. I.e. 0-30 seconds section contains song file stream, 31-50 seconds section contains interruption and advertisement, 51-1:15 seconds contains more snippet of song, 1:16-2:00 seconds section contains vendor advertisement, 2:01 seconds section contains more song snippet, or the like;

FIG. 5 is a flow chart showing a third-party advertisement slot where the advertisement slot may precede the intentional interruption, proceed the intentional interruption, or be incorporated into the intentional interruption, and for general advertisements, members are rewarded points for watching video ads, taking surveys on those ads;

FIG. 6 is a flow chart showing a cloning method where, once the intentional interruption is incorporated into the clients' (copyright owners') protected material, the copyright protected material with the added intentional interruption will be flooded into internet sites. The cloning method will confuse a large portion of individuals seeking to acquire the clients' (copyright owners') copyright protected material illegally, by releasing the clients' copyrighted material with the added intentional interruption, and make it seem as if the individuals are receiving the original version of the copyrighted material, when they are actually receiving the intentionally interrupted version of the clients' (copyright owners') protected materials i.e. an illegally downloaded song may be titled “new song”, or “new song (without intentional interruption)” but when the user plays the song, it indeed contains the intentional interruption. After “cloning” massive amounts of clients' (copyright owners') intentionally interrupted copyrighted material, when flooded, the third-party internet sites will contain clones;

FIG. 7 is a flow step showing a strategic flooding process where the client has the option to flood the file sharing channels with intentionally interrupted versions of their copyrighted material which were flooded from the control portal in an attempt to overshadow the presence of the already existing pirated copies of their protected materials i.e. if a website is distributing illegal copies of clients' copyrighted materials, the client may flood that website with the intentionally interrupted version of their copyrighted materials in order to dramatically decrease the convenience and availability of the pirated materials;

FIG. 8 is a flow chart depicting an approach for strategically cloning without an interruption sequence mechanism implemented;

FIG. 9 is a flow chart depicting user accounts which includes a byte tracker; an up to date digital and/or physical tracking sheet of links of locations of copyright owners” material. A website with log-in capabilities to view account online, purchase clones, view clones, promote business, and the like, where users log into their accounts to check file data (bar graphs, line graphs, area graphs, etc.) of their registered service files showing how many times a particular file is viewed, played downloads, and dislikes. Users can also log into their accounts to purchase and/or view existing or expired clones;

FIG. 10 is a flow chart depicting an approach for users flooding their material into the matrix where a file is uploaded into clone generator, the copyright protected material with the tracking number will be flooded into matrix, and the matrix is an open portal in which shows ads, videos, music, photos, games, eBooks, files, etc. from other internet channels (sites, including other matrixes which are sourced to the main matrix). All of which are linked to specific tracking number;

FIG. 11 is a flow chart depicting an approach for members flooding their material into the matrix and internet channels (other matrix sites or sites in general) sourcing to the main plant gall matrix control portal where the copyright protected material with the tracking number will be flooded into matrix from other internet channels (sites, including other matrixes which are sourced to the main matrix) and the matrix is an open portal in which shows ads, videos, music, eBooks, files, etc. from other internet channels (sites, including other matrixes which are sourced to the main matrix). All of which are linked to specific tracking number;

FIG. 12 is a depicting the overall process of business model via control portal to matrix to internet channels, where the user logs in to backdoor and uploads a file of choice into clone generator to clone or market and/or add an interruption sequence to that file, the file is cloned into the matrix portal and/or internet sites, and the byte tracker in backdoor displays the analytics for that file(s) and each has a tracking number of its own;

FIG. 13 is a flow chart depicting the process of the stock option, reward and discount functionality, where (a) the user decides to invest points into another particular file; (b) the user decides how many shares of that file they want to invest; (c) the file for a user has a certain amount of days to increase stock value numerically. If the stock performs well after the stock day cycle has ended, the users whom have invested will earn more points. However, if the stock does not perform well, the user(s) lose points; (d) points are used to receive discounts on merchandise, tickets for events, discounts on music purchases, film tickets, games, eBook purchases and software; (e) the stock value is determined by an algorithm which is ultimately decided by end users on likes, dislikes, view and plays ratios; and (f) shares of stock can also be traded for stock in another file, or sold for points;

FIG. 14 is a flow chart depicting the AphidByte prints, where AphidByte prints are different versions of a file. The byte prints can be used for movies, videos, photos, songs, ebooks, files and games. Prints number to five different versions which can be selected by a drop down box or checkbox selection in backdoor through the clone generator. AphidByte prints and control portal software are inter-connected as a business model, service and method, where the control portal software may now be utilized to automatically place the selected intentional interruption within the copyrighted material; and

FIG. 15 is a chart depicting a profit sharing program which rewards members points, gifts for uploading and posting clones of clients files.

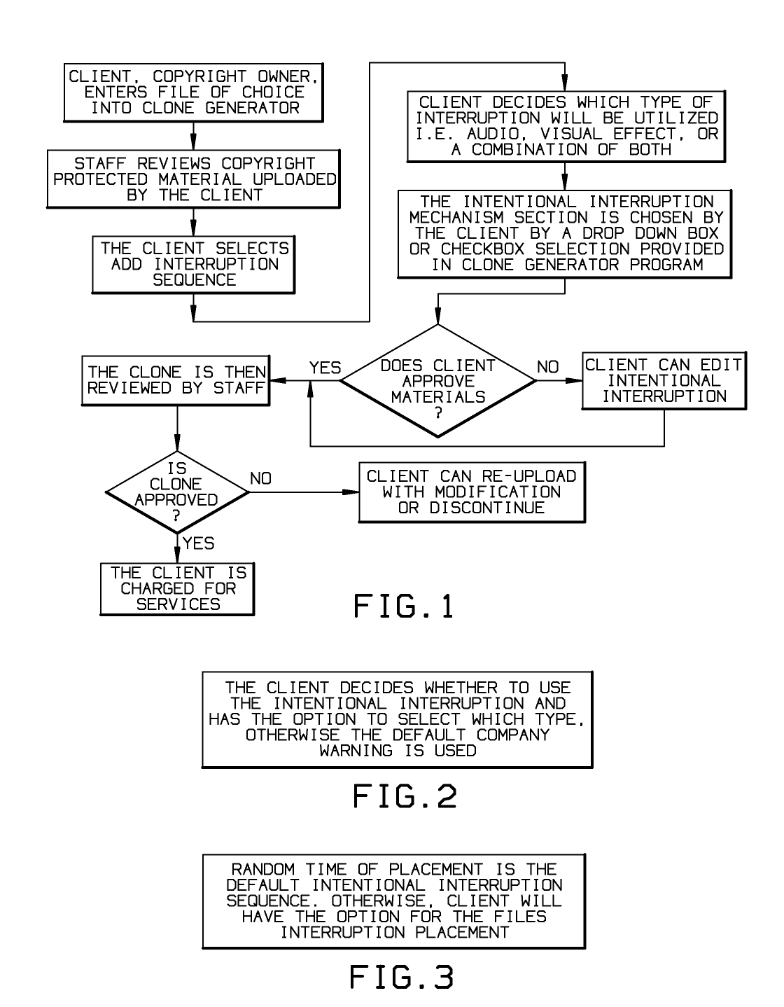

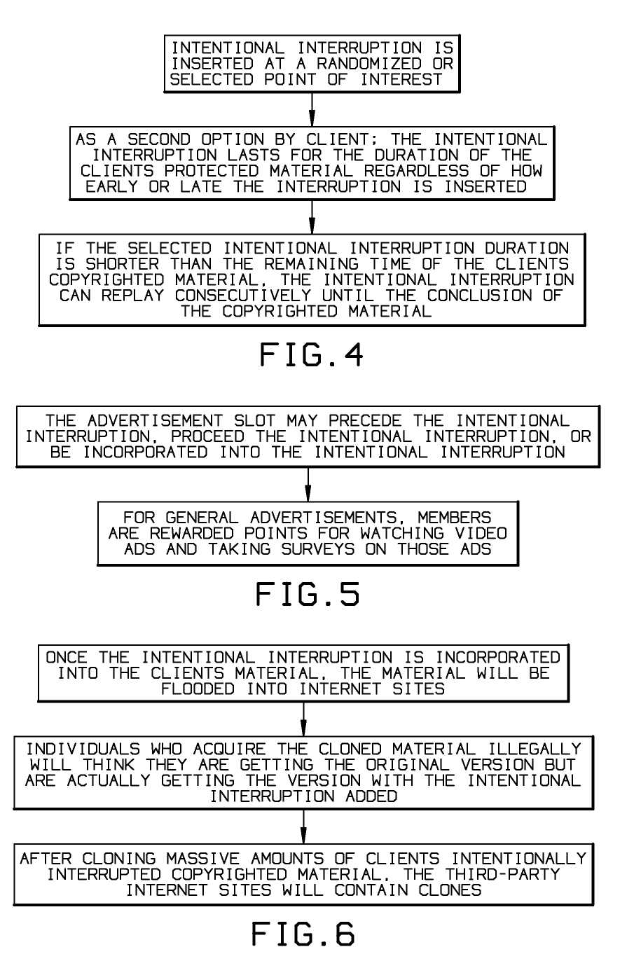

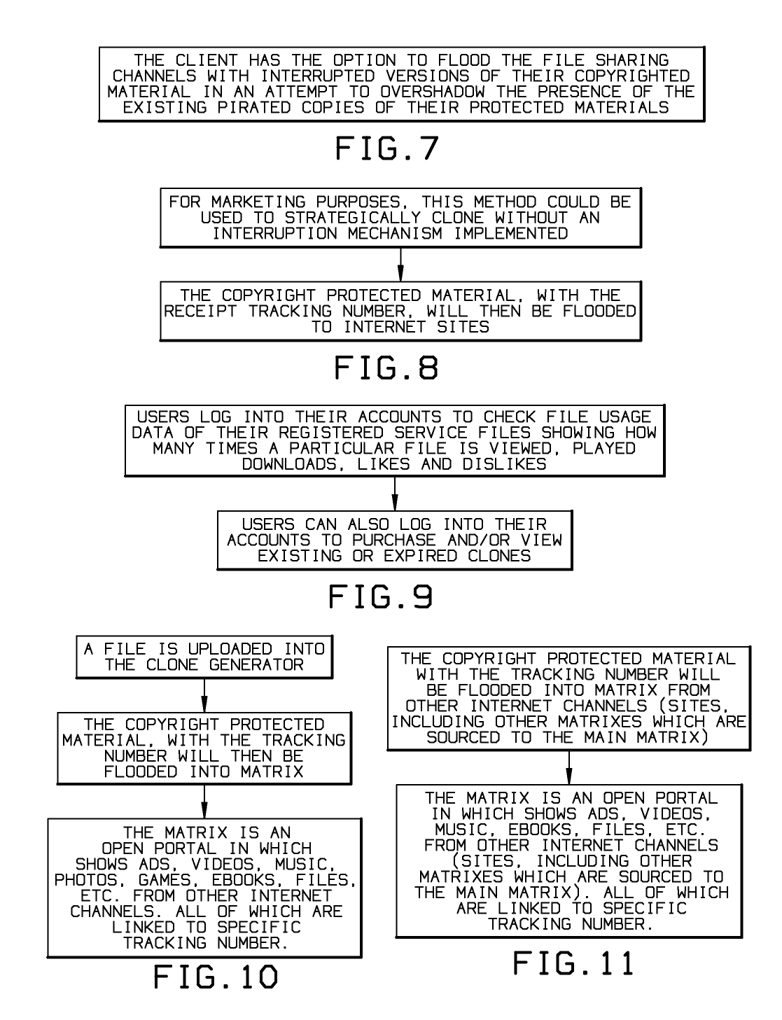

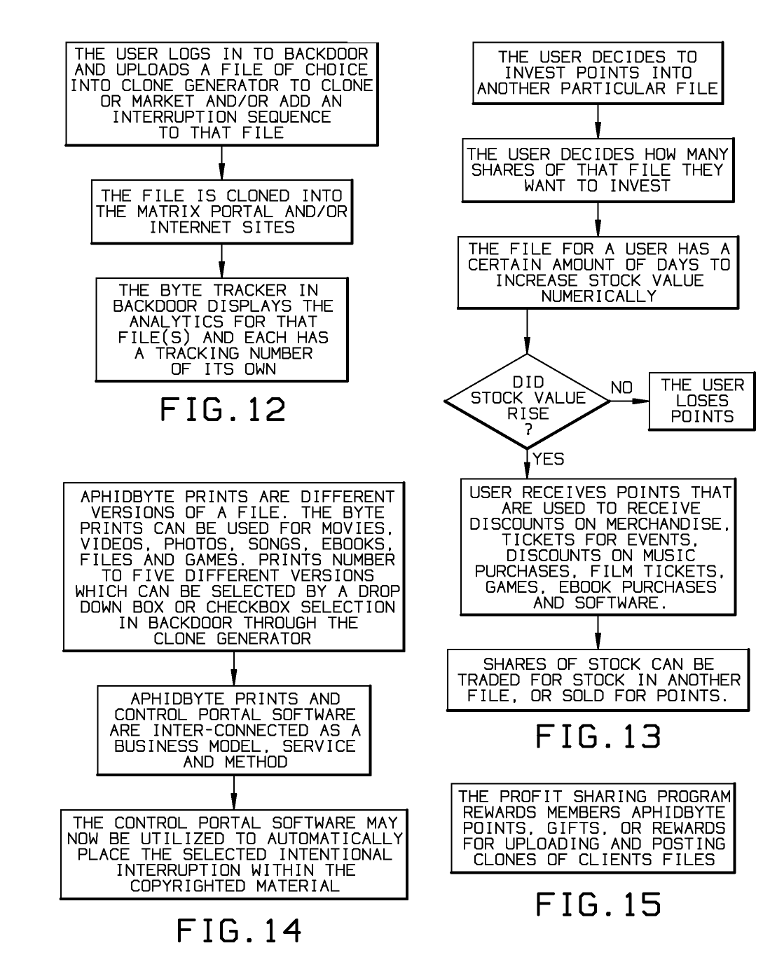

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method and system to protect and market copyright materials. The method and system of the present invention protects copyright materials by cutting the copyrighted material short, and/or editing by adding inserted interruptions sporadically and/or strategically throughout copyrighted material to cause enjoyment of viewing and/or listening to cease. By stopping the stream of continuous viewing and/or listening collectively out of sequence, will most likely cause pirate user to become uninterested. This is implemented with advertisement to direct pirate users to legitimately purchase the rightfully copyrighted material.

As used herein, the term “glitch” or “glitching” refers to an intentional interruption, or the act of adding an intentional interruption, as described in greater detail below.

Referring now to the Figures, an AphidByte business model and service method includes the following elements: intentional interrupting audio mechanism, intentional visual interrupting mechanism with or without audio, advertisement implementation, cloning method, how to determine which intentional interruption to use, strategic placing for intentional interruption, intentional interruption duration, time of placement for intentional interruption, and strategic flooding process, clone generator, and AphidByte prints. The control portal software is an additional feature of the business model.

The above elements are connected as follows. The clone generator, which is the functional file clone conversion unit where members upload their copyrighted material into the plant gall matrix control portal and internet sites, allows the intentional interrupting audio mechanism and/or intentional visual interrupting mechanism with or without audio to be implemented into the original copyrighted material of copyright owner(s) composing one file. This composed file is then duplicated using the cloning method to flood the market through distribution outlets. The intentional interrupting audio mechanism is an element that is combined with vocal copyrighted material through track-layered recording and editing i.e. music songs, audio books, audio within visual interruptions, etc. The intentional visual interrupting mechanism with or without audio is an element that is combined with visual copyrighted material through track layered recording i.e. movies, videos, etc. The intentional visual interrupting mechanism with or without audio also is connected with photo watermarking for members.

The intentional interruption duration has no set determination of length in general. The intentional interrupting audio mechanism and/or intentional visual interrupting mechanism with or without audio, ingresses at any given selected section of interest pertaining to copyright owner(s) desires within copyrighted material. The strategic placing for intentional interruption is determined by copyright owner(s). The strategic placing for intentional interruption is used in a method where copyright owner(s) and/or service providers preferably insist is the best section of copyrighted material that halts consumer(s) after the utmost culminating point of interest. The preceding strategy is optional and is subject to change if requested by copyright owner(s). The strategic placing for intentional interruption can be inserted with any desired intentional interruption duration of copyright owners' choosing. Files are uploaded into the clone generator. The copyright owner(s) then decides which type of interruption will be utilized i.e. audio, visual effect, or a combination of both. Next, the files are reviewed by service provider's staff. If disapproved, no charge will be applied to account and client has the option to edit, upload, and resend for approval or discontinue. If approved, a clone data fee is charged to the members' account.

In terms of how to determine which intentional interruption to use, the client decides which intentional interruption (audio, visual effect, and/or a combination of both) to incorporate into the materials i.e. if the copyright protected material is an audio file, the client should select the “Byte Your Music” section in backdoor.

The time of placement for intentional interruption can be determined by copyright owner(s). The intentional interruption can be inserted into specific or random sections of copyrighted material. A drop down or checkbox option allows the member to select which time section to place interruption. The programming in the clone generator can automate the selected time frame and insert the intentional interruption.

Following this interruption is the advertisement implementation. The advertisement implementation can be determined by who has paid to fill advertisement slot which is normally copyright owner(s) or third-party advertisers.

The cloning method is the process of duplication via the clone generator. The copyright protected material, with or without the added intentional interruption, will be flooded into internet sites by the control of the member. The intentional interruption sequence is used to confuse a large portion of individuals seeking to acquire the pirated ownership of the clients' (copyright owners') copyright protected material, i.e., an illegally downloaded song may be titled “new song”, or “new song (without intentional interruption)” but when the user plays the song, it indeed contains the intentional interruption. Clones flooded without an intentional interruption sequence are primarily used for marketing purposes.

The strategic flooding process is the process that works after the product is finished. After copyrighted material has been modified by copyright owner(s), the clone generator begins the process of flooding internet channels with the clones of the interrupted copyright material. Files before being uploaded into the plant gall matrix control portal are scanned for viruses through virus scanning program(s).

AphidByte prints are different versions of a file, i.e., “B1: Song1” is the first version of the song, “B2: Song1” is the second version of the song and so on. The byte prints can be used for movies, videos, photos, songs, eBooks, files and games. Prints number to five different versions which can be selected by a drop down box or checkbox selection in backdoor through clone generator.

The control portal software may be utilized to automatically place the selected intentional interruption within the copyrighted material. The software works the same as the online clone generator, only difference is, the generator is in the form of software which can be used on a desktop of computer.

An AphidByte provides copyright owners' of music, film, eBooks, photos, and files with the service method of intentionally adding an interruption to an already copy written or non-copy written work with member permission. This intentional interruption is designed to reduce piracy amongst illegal distribution. The cloning method is used for marketing purposes if an interruption sequence is not added. The audio interruption provides an interfering noise effect for a specified period of time. The visual interruption causes a perturbing visual effect and/or audio interfering noise which causes viewer to immediately to be warned of piracy protection. Sole purpose is to enforce strict piracy laws for consumers of music, literary works, photography, and film for example and also to provide the most convenient service of guiding consumers to channels of purchasing legally. Copyright owner(s) and people who are not associated with service providers under contractual agreement are prohibited from directly using our method of service to users, advertisers, vendors, etc. (with or without compensation) without service providers' permission in advance. The intentional interrupting audio mechanism, intentional visual interrupting mechanism with or without audio, preferred advertisement implementation, cloning method, how to determine which intentional interruption to use, strategic placing for intentional interruption, intentional interruption duration, time of placement for intentional interruption, and strategic flooding process, clone generator, AphidByte prints, and control portal software are inter-connected as a business model, service and method.

One of the characteristics that make the present invention unique is the all-in-one system framework which includes a client-server system for delivering online information, an optional access control and monitoring system for network servers, optional electronic mail systems that display advertisements to remote users as well. The business model incorporates an intentional interrupting audio mechanism, intentional visual interrupting mechanism with or without audio, advertisement implementation, cloning method, how to determine which intentional interruption to use, strategic placing for intentional interruption, intentional interruption duration, time of placement for intentional interruption, and strategic flooding process, clone generator, and AphidByte prints. The control portal software is additional but can be used within business method. The cloning method can be executed with or without text specific warning i.e. “Song A (with AphidByte)”, “Song A (without AphidByte)” (contains AphidByte but does not display indicator in text) or “Song A” (contains AphidByte but does not display indicator in text). Also the composed file can be used with false text indicator with permission, to reduce pirates from knowing which song is which, i.e., displays in text as “Movie A (without AphidByte)” but actually contains AphidByte. The cloning method system to reduplicate copyrighted materials is with the consent of copyrighted owner(s). These clones of the finalized interrupted composed or uninterrupted file will be placed into multiple distribution channels in massive volumes. Each element is designed with its own unique feature from intentional interrupting audio mechanism, intentional visual interrupting mechanism with or without audio preferred advertisement implementation, cloning method, how to determine which intentional interruption to use, strategic placing for intentional interruption, intentional interruption duration, time of placement for intentional interruption, and strategic flooding process, clone generator, and AphidByte prints. The control portal software is not required but can be used within business method. These elements are used collectively as one combined business model. What makes AphidByte new and different is its very useful and solves a problem for copyright owner(s) whose diligent and hard work is taken away due to illegal distribution of material. When AphidByte is used, it reduces the known problems of piracy and as it relates to illegal distributed material. AphidByte provides copyright owners' with a service method of business with the intent to increase their revenues by gaining sales of legal purchases, advertise and to reduce piracy of their copyrighted materials.

It should be understood, of course, that the foregoing relates to exemplary embodiments of the invention and that modifications may be made without departing from the spirit and scope of the invention as set forth in the following claims.

What is claimed is:

1. An implemented method for reducing unauthorized distribution of copyrighted materials, the method comprising:
incorporating an intentional interruption into copyrighted material in a form of at least one of an audio and visual effect that causes one or more attributes of the resulting intentionally interrupted copyrighted material to be displayed;
establishing, in at least one of an audio and visual effect form, from copyrighted materials received from copyright owners, an intentional interruption mechanism incorporated within copyrighted materials, wherein the intentionally interrupted material comprise at least one of a warning, comedy advertisement and general advertisement; and
causing to be displayed to a recipient a warning, comical skit or advertisement discouraging illegal acquisition of copyrighted materials, a marketing/advertising commercial by copyright owners and official vendors of copyrighted material, and the abrupt ending of illegally acquired copyrighted material playing at the time.

2. The implemented method as recited in claim 1, wherein the form of the intentional interruption utilized is selected by the copyright owner.

3. The implemented method as recited in claim 1, wherein the intentional interruption placement is determined by random selection by the copyright owner.

4. The implemented method as recited in claim 3, wherein the random selection for the placement of the intentional interruption generated automatically by a clone generator or software which uses a strategy to randomly select a point at which the intentional interruption will occur.

5. The implemented method as recited in claim 1, wherein the intentional interruption duration is the remainder of the copyright owner's protected material regardless of how early or late the intentional interruption is inserted.

6. The implemented method as recited in claim 5, wherein if the selected intentional interruption duration is shorter than the remaining time of the copyright owner's copyrighted material, the intentional interruption will replay consecutively until a conclusion of the copyrighted material.

7. The implemented method as recited in claim 1, wherein a marketing/advertisement slot is available as part of the intentional interruption for ads to be placed by a service providers, the copyright owners, or a legitimate vendors of the copyright owner's products.

8. The implemented method as recited in claim 1, further comprising logging in to a portal and uploading a file into clone generator.

9. The implemented method as recited in claim 1, further comprising adding an interruption sequence.

10. The implemented method as recited in claim 1, wherein the copyright owner's material that receives the intentional interruption is cloned and distributed in mass quantities to matrix and internet sites to dramatically decrease an amount of illegally distributed copyright materials available for acquisition.

11. The implemented method as recited in claim 10, wherein the copyright owner's intentionally interrupted materials, which are distributed in mass quantities, are presented in a manner that raises speculation to a pirate as to whether they are receiving sought after unauthorized copyrighted material, and, when the pirate accesses the intentionally interrupted material, it contains the intentional interruption.

12. The implemented method as recited in claim 1, further comprising creating different versions of a file by drop down menu or checkbox selection.

13. The implemented method as recited in claim 12, wherein copyright owners are charged in exchange for a flood of clones based on quantity.

14. The implemented method as recited in claim 1, wherein users invest points in stock of a members file(s) for shares which determine point gain or loss, which are used for rewards and discounts.

15. The implemented method as recited in claim 1, wherein the intentional interruption, regardless of the form, is placed on various sources of copyrighted material(s) including uploaded files and physical copies of the copyrighted material(s).
